(19) United States
(12) Patent Application Publication
(10) Pub. No.: US 2008/0171954 A1
(43) Pub. Date: Jul. 17, 2008

(54) Vibration therapy device

(76) Inventors: Andreas Guenther, Monaco (MC); Thomas Vogt, Schaan (LI)

Correspondence Address: MUIRHEAD AND SATURNELLI, LLC, 200 FRIBERG PARKWAY, SUITE 1001, WESTBOROUGH, MA, 01581, US

(21) Appl. No.: 12/009,316

(22) Filed: Jan. 17, 2008

(30) Foreign Application Priority Data
Jan. 17, 2007 (DE) 10 2007 003 361.5

(51) Int. Cl. A61H 23/02

(52) U.S. Cl. 601/15; 601/78; 601/47

(57) ABSTRACT

A device for transmitting vibrations to a person has a supporting element for receiving a human body and at least one vibration generator situated on the back side of the supporting element, which generates vibrations using an electromagnet. A shield made of a material that shields magnetic fields is situated between the supporting element and the electromagnet, and at least one electrical conductor is situated between the shield and the supporting element or on the supporting element for generating a magnetic field.

### TECHNICAL AREA

The present invention relates to a device for transmitting vibrations to a person, having a supporting element for receiving a human body and having at least one vibration generator situated on the back side of the supporting element, which generates vibrations using an electromagnet.

### STATE OF THE ART

Devices of this type may be referred to in general as vibration therapy devices or sound therapy devices. They are essentially designed as a piece of seating furniture or lying furniture, the supporting element preferably forming a seating surface or a lying surface. The devices include electromagnetic transformers which convert electric currents into vibrations or sound. Document DE 26 14 972 describes such a device in which, on the one hand, sound waves are generated by an electroacoustic transformer and, on the other hand, an electromechanical transformer generates low-frequency vibrations.

Further devices of this type are known from the documents DE 202 08 228 U1, DE 35 22 305 C2, DE 201 13 443 U1, EP 0 441 802 B1, EP 1 491 228A2, EP 0 244 508 B1, EP 0 224 102 B1, WO 2005/030011 A1, EP 0 422 253 A1, EP 0 352 569 B1, EP 0 296 231 B1, EP 1 325 727 A2, and WO 2005/020869 A1.

The different nature of the vibrations transmitted to the human body is elucidated in the above-mentioned DE 26 14 972 C3. While electroacoustic transformers such as a speaker generate vibrations in the audible frequency range via a diaphragm, electromagnetic vibrotactile transducers transmit vibrations directly to the supporting element via a rigid coupling.

It has been found that the transmission of vibrations (sound waves or oscillations) to a human being resting in a relaxed posture on a supporting element has a calming and relaxing effect on the human being. Sound waves and vibrations are preferably transmitted to the human body simultaneously. The combination of the two different signals increases the relaxing effect.

Documents proposing a device for a combination of sound therapy and vibration therapy include, for example, US 2005/0154249 A1, DE 101 09 429 A1, DE 100 60 306 A1, DE 44 31 661 A1, and U.S. Pat. No. 4,326,506.

US 2005/0154249 A1 proposes permanent magnets for generating a magnetic field. This does not permit to generate time-variable magnetic fields which have been found particularly effective in magnetic field therapy. Furthermore, the above-mentioned document DE 101 09 429 A1 describes a therapeutic piece of seating and/or lying furniture having a seating and/or lying surface which has at least one associated magnetic field coil to which an amplifier applies a time-variable signal for generating a time-variable magnetic field. To allow the therapeutic application options to be expanded, it is proposed that the at least one coil be a component of an electroacoustic transformer and that the seating and/or lying surface be excited with the aid of the electroacoustic transformer to emit acoustic vibrations. In this device, the time-variable magnetic field, which acts upon a human being lying on the seating/lying surface, is therefore simultaneously used for generating the acoustic vibrations. The acoustic vibrations must necessarily be synchronous with the fluctuations of the magnetic field acting upon the human being. Documents DE 196 05 777 A1 and U.S. Pat. No. 4,326,506 also propose that the magnetic field of the vibration generator's coil be made to act on the body.

### DISCLOSURE OF THE INVENTION

The object of the present invention is to refine the generic device in such a way that its positive effect on a human's well-being is enhanced.

This object is achieved according to the present invention in that a shield made of a material that shields magnetic fields is situated between the supporting element and the electromagnet, and at least one electrical conductor is situated between the shield and the supporting element or on the supporting element for generating a magnetic field.

In other words, it is proposed that a known device for transmitting vibrations to the human body be combined with a magnetic field therapy device, the magnetic fields of the vibration generators being isolated from the magnetic fields acting upon the human body. For this purpose, the magnetic fields which are generated by the electromagnet of the vibration generator (speaker and/or vibration generator) are shielded. A shield which weakens the magnetic field is situated between the supporting element and the electromagnet. A ferromagnetic material such as iron is suitable for this purpose. At the same time, at least one electrical conductor for generating a defined magnetic field for performing magnetic field therapy is situated above the shield, i.e., between the shield and the supporting element or on the supporting element.

Magnetic field therapy devices are known, for example, from the document DE 103 04 085 A1. They have, for example, mat-type devices which accommodate electrical conductor tracks. The electrical conductor tracks are connected to a control unit via connecting cables and plug-in connectors. Current is introduced into the electrical conductor tracks of the magnetic field mat via the control unit for generating a magnetic field above the magnetic field mat. The current is variable over time and preferably flows in individual pulses which are combined to form pulse groups separated by pauses between two pulse groups. The shape and frequency of the individual current pulses, the time-variable amplitude of the current pulses, and the pause between the consecutive pulse groups substantially influence the effect of the magnetic field on the patient's body. In the magnetic field therapy device of the above-mentioned document, these variables may be controlled as a function of a value which is detected by a biosensor (pulse sensor, blood pressure sensor, etc.).

The magnetic vibrations which are obtained from the vibration generators when the vibrations are generated usually have a form that is different from the optimum fluctuations over time of the magnetic field generated by the conductor and acting upon the human body.

To ensure proper function of the magnetic field therapy device implemented by the conductor tracks, interfering or parasitary magnetic fields, in particular the magnetic fields originating from the electromagnet of the vibration generator, must be shielded with respect to the human body situated on the supporting element. It is thus ensured that only the therapeutic magnetic fields generated by the conductor track act upon the human body and achieve the intended therapeutic effect. Although the magnetic fields acting upon the human body may be synchronized with the magnetic fields for the excitation of vibrations, they do not need to be synchronous. Due to the shield, the two magnetic fields may be generated independently from each other and without mutually influencing each other.

In practice, the electromagnet may be situated in a housing which is made of a material that shields the magnetic fields and forms the shield.

Alternatively or additionally, a plate made of a material that shields magnetic fields may be situated on or underneath the supporting element. Plates of this type allow effective reductions of the magnetic field intensity acting above the supporting element to be achieved. The combination of the two shields (housing and shield plate) achieves an even greater reduction of the parasitary magnetic fields, but it is more expensive and weighs more.

As mentioned before, the magnetic shield is preferably made of an electrically conductive and ferromagnetic material, in particular of iron. The electrical conductivity counteracts the high-frequency magnetic fields. The ferromagnetic property shields low-frequency magnetic fields having, for example, a supply frequency (50 Hz to 60 Hz).

The electrical conductor for generating a magnetic field acting upon the human body above the supporting element may be applied to a surface of the supporting element. The electrical conductor may be integrated, in particular, into a mat-type structure made of padding material, which is placed on top of the supporting element.

In a preferred embodiment, the electrical conductor is fixedly connected to a surface of the supporting element. The electrical conductor may be glued, for example, on the top or bottom surface of the supporting element. The fixed connection of the conductor to the supporting element has the advantage that the conductor is integrated into the overall structure of the therapy device. In a specific embodiment, the electrical conductor is embedded into the supporting element. For this purpose, the supporting element may be made, at least partially, of plastic material into which the electrical conductor is integrated. For example, the supporting element may be formed by a plate-type component, the electrical conductor being placed on a surface of this component and fixedly bonded thereto via a synthetic resin such as an epoxy resin. The synthetic resin or epoxy resin forms, after setting, a closed plastic layer into which the electrical conductor is integrated.

In particular, when the plate-type component is made of a high grade material (such as wood), the electrical conductor may be applied as described above to the bottom surface of the plate-shaped component. However, the electrical conductor may also be applied to and encapsulated with the top surface. A transparent epoxy resin is used in this case if the structure of the supporting element, including the conductor integrated therein, is to be visible.

In practice, the electrical conductor may have the shape of a flat coil, i.e., run as a spiral. One preferred form of the arrangement of the electrical conductor in the area of the lying surface is described, for example, in the document DE 103 04 093 A1.

In a preferred embodiment, the device may have a shell-type support, which forms an upper opening covered by the plane supporting element. The shell-type design provides the device with a resonance body. The shell-type support forms, together with the plane supporting element closing the upper opening, a resonance body which amplifies the vibrations if these are conducted into the supporting element with the aid of the electromagnet. The power required for generating the vibrations may thus be reduced.

The therapeutic effect of the device according to the present invention may be further enhanced by situating at least one light source above the supporting element. The head area of the person lying on the supporting element may be illuminated by the light source. The color and/or the radiation intensity of the light source are/is preferably controllable. The vibration therapy or sound therapy may therefore be combined not only with a magnetic field therapy, but also with a light therapy. Light pulses or color changes may be tuned to the vibrations and therapeutic magnetic fields generated by the device.

### BRIEF DESCRIPTION OF THE DRAWINGS

Embodiments of the present invention are described in the following with reference to the appended drawings.

FIG. 1 shows a schematic sectional view of a device according to the present invention;

FIG. 2 shows a schematic bottom view of a section of the vibration generator of the device according to the present invention;

FIG. 3 shows the side view of the vibration generator of FIG. 2;

FIG. 4 shows a top view onto the supporting element of the device according to the present invention;

FIG. 5 shows a perspective view of a support having a supporting element for the device according to the present invention in exploded view; and

FIG. 6 shows a perspective overall view of the device according to the present invention of FIG. 5 having a light source for the light therapy.

### DETAILED DESCRIPTION OF THE INVENTION

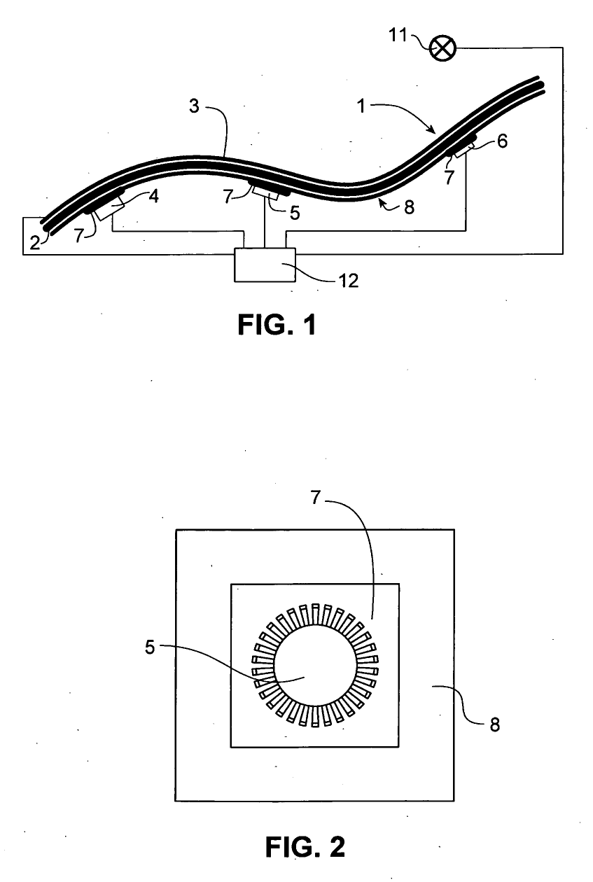

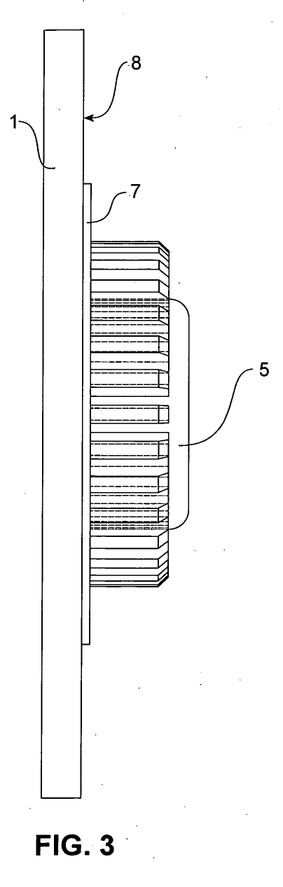

The device depicted in FIG. 1 for transmission of vibrations to a human body has a supporting element 1 which is designed in the present case as a lying surface. In the schematic illustration, supporting element 1 includes a hard core 2 and a padded cushion 3. Vibration generators 4, 5, 6 in which an electromagnet generates mechanical vibrations in the known manner are situated on the bottom side or back side of core 2; the vibrations either are conducted into supporting element 1 or generate sound waves via diaphragms.

A plate-shaped shield 7, which in the present case is an iron plate, is provided between each vibration generator 4, 5, 6 and supporting element 1. Iron is a magnetically conductive material and shields the area above supporting element 1 against the magnetic radiation of vibration generators 4, 5, 6.

The back side of a vibration generator 5 is illustrated in an enlarged form in FIG. 2. Plate-shaped shield 7 made of iron considerably reduces the intensity of the magnetic field generated by the electromagnets of vibration generators 4, 5, 6 in the area above supporting element 1.

Alternatively, a solid iron plate may be provided on the back side of supporting element 1. However, this would result in a substantially greater weight.

FIG. 1 shows, in addition to sound generators 4, 5, 6, further signal generators, which have a therapeutic effect on a human body lying on supporting element 1. A light source 11 is illustrated above an area of supporting element 1 in which the head of the person lying on supporting element 1 is situated. The brightness and color of light source 11 are preferably controllable, so that the light signals are tuned to the generated vibrations and the magnetic alternating fields which act on the person lying on supporting element 1.

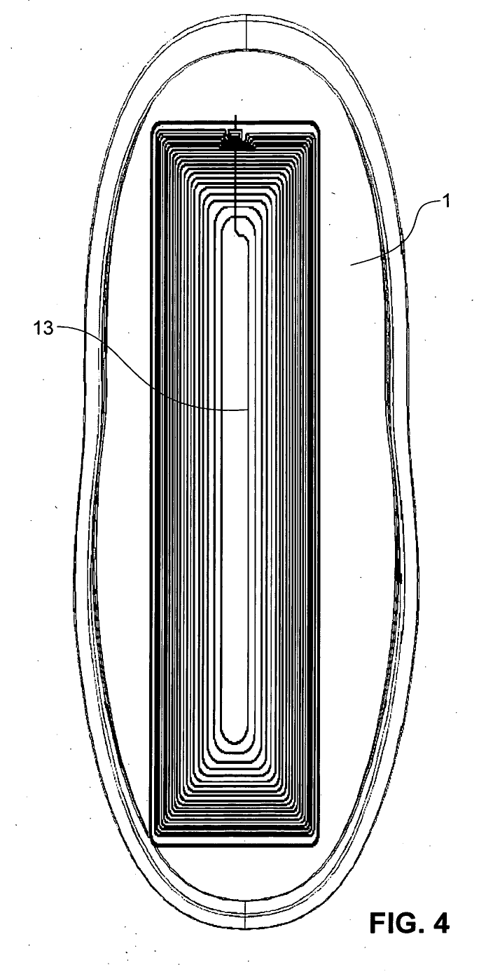

Sound generators 4, 5, 6 and light source 11 are controlled and operated by a shared control device 12. Control device 12 is connected to sound generators 4, 5, 6 and the light source via individual signal lines. A further signal line leads from control device 12 to supporting element 1. This further signal line conducts an electrical signal, which generates a dynamic magnetic field above supporting element 1, to an electrical conductor in the area of supporting element 1. FIG. 4 shows an embodiment of the electrical conductor in greater detail.

FIG. 4 shows a top view onto supporting element 1 which is illustrated sectioned in FIG. 1. The component may have a hard core 2, made of wood or plastic, for example, for supporting the weight of the person lying on it. An electrical conductor 13, essentially extending over the entire length and most of the width of supporting element 1 in the form of a quadrangular spiral, is provided on the top side of the supporting element. The conductor spiral may, however, also have other shapes; for example, it may be rounded. In addition, the conductor may follow other paths, for example wave-shaped or meandering paths.

Electrical conductor 13 is used for generating a magnetic field. It receives dynamic electric currents in pulses which generate an alternating magnetic field having a predefined pulse form and predefined intensity above supporting element 1 of the device. This alternating magnetic field is not disturbed by the magnetic fields of vibration generators 4, 5, 6 because these magnetic fields are shielded against the area above supporting element 1 via shields 7.

In the embodiment illustrated, electrical conductor 13 is fixedly connected to supporting element 1. For this purpose, it is placed on core 2 and encapsulated using a transparent synthetic resin. This procedure results in a very sturdy unit in which the device for generating the magnetic field is directly integrated in supporting element 1. The synthetic resin layer forms the top side of supporting element 1 and is transparent.

As explained in connection with FIG. 1, electrical conductor 13 is connected to control device 12 via a signal line and appropriate connection contacts. Control device 12 is usually an electronic signal generator which generates the currents required for controlling the different devices. Control device 12 is designed here as an operator's console and has operating controls which may be operated by the user of the device. The integration of electrical conductor 13 in the device according to the present invention and its shielding against the electromagnet of the sound generators and vibration generators 4, 5, 6 make a more versatile and more effective treatment of a person lying on supporting element 1 possible, the magnetic field generated by electrical conductor 13 not being interfered with or distorted by parasitary magnetic fields. Another variant of the therapeutic treatment may be achieved via light source 11.

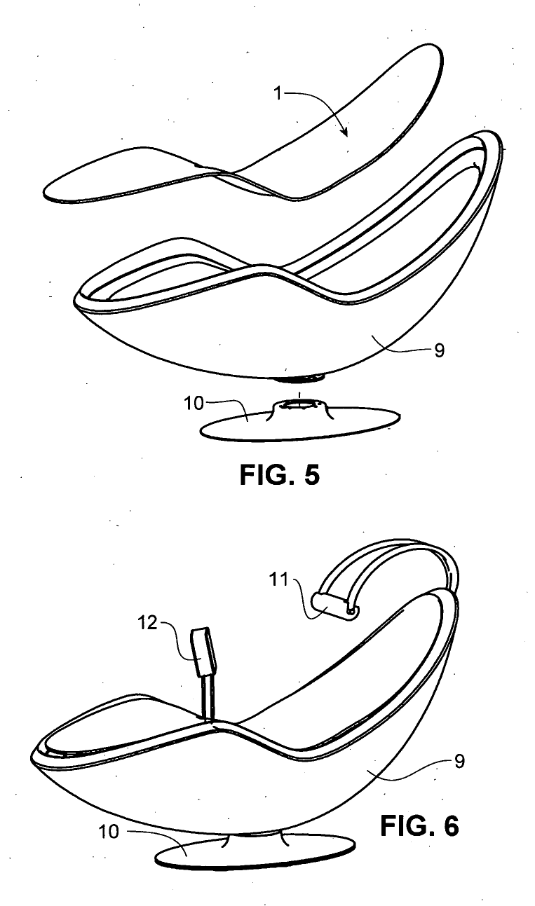

A practical embodiment of the device according to the present invention is illustrated in the perspective views of FIGS. 5 and 6. It is apparent that the device has a shell-type support 9, which has the approximate shape and dimensions of a bathtub. Shell-type support 9 forms an upper opening, which is covered by supporting element 1. Shell-type support 9 may be composed of two half-shells. Shell-type support 9 is preferably manufactured from thin-walled plastic material, having fiber reinforcement if necessary. Shell-type support 9 is secured on a base 10.

Shell-type support 9 forms, together with supporting element 1, a resonance body, which amplifies the vibrations induced by vibration generators 4, 5, 6.

As mentioned previously, vibration generators 4, 5, 6 may generate sound waves or vibrations of supporting element 1.

FIG. 6 illustrates a perspective side view of the assembled device according to the present invention. It also shows a support for light source 11 above the head area of the person lying on supporting element 1 and a control device 12, using which the device according to the present invention may be operated.

### LIST OF REFERENCE NUMERALS

1 supporting element
2 core
3 cushion
4 vibration generator
5 vibration generator
6 vibration generator
7 shield
8 back side
9 shell-type support
10 base
11 light source
12 control device
13 electrical conductor

1. A device for transmitting vibrations to a person, comprising:
a supporting element for receiving a human body;
at least one vibration generator situated on the back side of the supporting element, which generates vibrations with the aid of an electromagnet;
a shield made of a material that shields magnetic fields situated between the supporting element and the electromagnet; and
at least one electrical conductor situated between the shield and the supporting element or on the supporting element for generating a magnetic field.

2. The device as recited in claim 1, wherein the electromagnet is situated in a housing and the housing is made of a material that shields magnetic fields.

3. The device as recited in claim 1, wherein the shield includes a plate made of a material that shields magnetic fields and is situated on or underneath the supporting element.

4. The device as recited in claim 1, wherein the material that shields magnetic fields is a ferromagnetic material.

5. The device as recited in claim 1, wherein the material that shields magnetic fields is iron.

6. The device as recited in claim 1, wherein the electrical conductor for generating a magnetic field is applied to a surface of the supporting element.

7. The device as recited claim 1, wherein the electrical conductor is embedded into the supporting element.

8. The device as recited in claim 7, wherein the supporting element is made of a plastic material.

9. The device as recited in claim 1, further comprising:
a shell-type support, which forms an upper opening covered by the supporting element.

10. The device as recited in claim 1, further comprising:
at least one light source above the supporting element.

11. The device as recited in claim 6, wherein the electrical conductor is glued to the surface of the supporting element.

12. A vibration therapy device, comprising:
a supporting element;
an electromagnet;
a vibration generator disposed on the supporting element, wherein the vibration generator generates vibrations using the electromagnet;
a shield that shields magnetic fields, wherein the shield is disposed between the supporting element and the electromagnet; and
an electrical conductor for generating a magnetic field, wherein the electrical conductor is disposed between the shield and the supporting element or on the supporting element.

13. The vibration therapy device as recited in claim 12, further comprising:
a control device that generates control signals, wherein the control device is coupled to the electrical conductor.

14. The vibration therapy device as recited in claim 12, further comprising:
a light source disposed above the supporting element.

15. The vibration therapy device as recited in claim 14, wherein the light source is controlled to generated light signals tuned to the vibrations generated by the vibration generator.

16. The vibration therapy device as recited in claim 12, further comprising:
a housing that houses the electromagnet and shields magnetic fields.

17. The vibration therapy device as recited in claim 12, further comprising:
a shell-type support coupled to the supporting element to form a resonance area that amplifies the vibrations generated by the vibration generator.

18. The vibration therapy device as recited in claim 12, wherein the vibration generator conducts the vibrations into the supporting element.

19. The vibration therapy device as recited in claim 12, further comprising:
a diaphragm, wherein the vibration generator uses the diaphragm to generate sound waves.

20. The vibration therapy device as recited in claim 12, wherein the shield is a magnetically-conductive plate.
